(19) United States
(12) Patent Application Publication
(10) Pub. No.: US 2006/0289447 A1
(43) Pub. Date: Dec. 28, 2006

(54) HEATING CHUCK ASSEMBLY

(76) Inventor: Zakaria A. Mohamed, Golden Valley, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 11/277,391

(22) Filed: Mar. 24, 2006

Related U.S. Application Data
(60) Provisional application No. 60/692,114, filed on Jun. 20, 2005.

(51) Int. Cl. H05B 3/68

(52) U.S. Cl. 219/444.1

(57) ABSTRACT

A heating chuck assembly for wafer processing is provided, including heating modalities for same. The assembly generally includes hermetically sealed opposingly paired discs, and housed therebetween, a ceramic element interposed between first and second heating elements. The first heating element is adjacent a first disc of the opposingly paired discs so as to be paired therewith, the second heating element adjacent a second disc of the opposingly paired discs so as to be paired therewith. The assembly further contemplates the inclusion of temperature sensing/measuring and controlling devices, in the context of a heating chuck system.

This is a regular application filed under 35 U.S.C. §111(a) claiming priority under 35 U.S.C. §119(e) (1), of provisional application Ser. No. 60/692,114, having a filing date of Jun. 20, 2005.

### TECHNICAL FIELD

The present invention generally relates to thermal processing of semiconductor wafers, more particularly, to a temperature controlled semiconductor wafer chuck assembly equipped and/or configured so as to promote thermal uniformity during high thermal wafer processing, i.e., up to about 600° C.

### BACKGROUND OF THE INVENTION

Semiconductor device manufacturing, more particularly, integrated circuit fabrication, is dependent upon a requisite supply of semiconductor wafers. The market is large, with capital equipment spending totaling $29.9 billion in 2003, a 7.9 percent increase from 2002 (see http://www.future-fab.com/welcome.asp).

A typical wafer is made of extremely pure silicon that is grown into mono-crystalline ingots up to about twelve inches in diameter, using, e.g., the Czochralski process. The resulting ingots are thereafter sliced into wafers of select thickness, e.g., 0.75 mm, lapped, etched, and polished. Once prepared, numerous wafer processing steps, e.g., front end processing, back end processing, testing, and, packaging, are necessary to produced the desired semiconductor integrated circuit.

Typical front end processing includes preparation of the wafer surface, silicon dioxide growth, patterning and subsequent implantation or dopant diffusion to obtain sought after electrical properties, and growth/deposition of a gate dielectric or isolating insulation. Having “created” the devices, circuit forming interconnections are required. This back end process generally involves depositing layers of metal and insulating material, and etching the deposition into select patterns. Upon completion of the back end processing, the semiconductor devices are subject to a variety of electrical tests to ascertain, i.e., verify, functionality. The proportion of devices on the wafer found to satisfactorily perform is referred to as “yield.”

In furtherance of executing one or more of the subject wafer processing steps, the work piece, i.e., a wafer, is commonly held by a wafer chuck, i.e., a chuck or shafted pedestal assembly. Oftentimes it is necessary to control the temperature of the wafer during processing, and for this purpose, the semiconductor wafer chuck can be a temperature controlled chuck. Heated chucks and shafted pedestal heaters are ideally used in critical in-situ wafer processing applications where proximity to the wafer requires precise thermal, electrical, metallurgic and mechanical specifications.

A variety of known teachings are alleged to generally improve semiconductor wafer surface temperature uniformity during select wafer processing operations. For example, U.S. Pat. No. 5,467,220 (Xu) incorporates a yoke having a parabolic or elliptical surface which acts as a reflector in a wafer pedestal assembly. Reflector positioning and spacing relative to the wafer surface encourage reflection of heat radiated from the edge portion on the wafer surface and wafer chuck back to the wafer edge to mitigate thermal loss at the wafer edge, and thereby improve temperature uniformity across the surface of the wafer.

U.S. Pat. No. 6,278,600 (Shamouilian et al.) provides an electrostatic chuck having a flex circuit laminated to a contoured support pedestal. The top surface of the chuck has a contoured topography achieved by machining the upper surface of the pedestal prior to lamination of the flex circuit to the pedestal. It is believed that the contoured topography improves the flow of backside cooling gas resulting in a uniform wafer temperature profile.

U.S. Pat. No. 6,583,638 (Costello et al.) provides a chuck assembly comprising a primary heater interposed between a chuck top plate and a multi-layer heat sink, with a secondary heater fitted to the bottom or the underside of heat sink. The secondary heater is intended to work against the cooling affect of the heat sink and thereby eliminate extreme variations in the temperature of the bottom of the chuck due to action of the primary heater, as well as the cooler of the chuck.

Finally, U.S. Pat. No. 6,967,177 (May et al.) discloses an apparatus for controlling substrate temperature of a substrate during processing thereof at a process energy. Upon sensing chuck temperature outside a target temperature range, a controller is used to adjust a flow rate of a thermal transfer media flow, the temperature of the thermal transfer media, and the process energy to bring the sense chuck temperature within the target temperature range.

High temperature heating chucks, e.g., sandwiched pedestal assemblies (see FIG. 1), generally comprise two hermetically sealed metal or ceramic discs 11, 13 which house a combination of elements 15 such as a heater (e.g., a mica heater, i.e., etched Inconel® foil between two layers of mica sheeting), ceramic paper, Kapton®, silicon rubber, etc. Such assemblies are further characterized by combinations of sensors, controllers, cabling and other electrical and or mechanical components, as well as tight dimensional tolerances, surface flatness, perpendicularity, and a select surface finish.

As is to be expected, temperature specifications and tolerances of heating chucks are a function of the wafer process, e.g., chemical vapor deposition (CVD), plasma enhanced chemical vapor deposition (PECVD), lithography, baking, plasma etching, cleaning, etc. Generally, thin flexible heaters or heating elements (e.g., thermofoil heaters) are advantageously utilized in heating chuck assemblies. Characteristic heaters available for the semiconductor industry are twofold, namely, low temperature, i.e., up to about 260° C., all polyamide heaters laminated to heat sinks (e.g., AP heaters by Minco, Minneapolis, Minn.) and high temperature, i.e., up to about 600° C., mica heaters (e.g., models HM—by Minco, Minneapolis, Minn.).

Wafers whose diameters are 200 mm and 300 mm are most pervasive, and, inasmuch as the 300 mm wafers offer 125% more area than the 200 mm wafers, they are increasingly used in the industry. As larger wafers enable lower production costs, the most commonly used heating chucks are also 300 mm in diameter, however, as heating chucks become larger, it becomes more difficult to control the thermal tolerances during wafer processing. As a result, problematic thermal warping of the wafer is becoming increasingly common (see generally, “The Benefit of Using Double Heaters to Reduce Thermal Deformations of Heating Chuck Assemblies for Semiconductor Applications,” Mohamed, Zakaria, [publication date/bibliographic data], incorporated herein by reference).

The thermal process control of both the wafer and the heating chucks are critical to wafer processing as operating temperatures are generally controlling, e.g., operating temperatures dictate, among other things, reaction kinetics of the chemical reactions of the wafer process. As previously alluded to, during such processes, layers of gases or thin films are deposited to form a solid insulating or conducting layer on the surface of a wafer. The gases react with material on the substrate thereby creating a thin film that has desirable electrical properties. High-quality films are those with a uniform chemical composition and thickness across the entire substrate area. The thermal process controls the density of the thin film deposited, which is also crucial to the overall wafer quality.

In CVD processing, a gas containing metal or an insulating chemical is sprayed onto the surface of the wafer. These gases react on the heated wafer surface, forming a thin film of solid material. Energy sources such as heat or radio frequency (rf) power are used alone, or in combination, to facilitate this reaction. These CVD films range in thickness from a small fraction of a micron to a few microns, and must be deposited with extreme uniformity across the wafer surface. Thereafter, the wafer is cut to small chips that are used to create integrated circuits and electronic devices.

The wafers are generally processed inside clean vacuum chambers in order to be free of impurities and out-gassing. Ideally, the chambers are maintained at one atmosphere vacuum pressure. The temperatures and pressures of the vacuum chamber remain constant throughout the process without any disturbances or variations.

In addition to the strict environmental controls employed in the vacuum chamber, minimization of thermal disturbances is also critical to the creation of high-quality wafers. Reductions of temperature gradients across a heater lead to less variability in the temperature-dependent chemical reactions, which, in return, lead to higher production yield. In addition, the maintenance of dimensional tolerances of the heating chucks is crucial to the attainment of uniform heating. Any thermal deformation or warping of the chuck surface creates nonuniform temperatures across the wafer.

The general industrial requirements for temperature tolerances generally are ±1%, or less, of the operating temperatures. The usual tolerances for flatness are 0.001-0.005 inches. The criteria of temperature and flatness must co-exist in order to achieve high yields of the process. In addition, other issues such as the lifetime, fatigue, and cycling that occurs daily (i.e., “on” and “off” depending on the operating and process time) are some factors which effect the performances of these chucks.

Finally, the quality of the heating chuck surface finish can effect the temperature uniformity as well. Heat loss through radiation, which depends on the reflectivity and the color of the surface finish, also affect the temperature uniformity of the surfaces. Therefore, the operational control of temperature variation, surface finish, and flatness during thermal processing are essential to productive wafer production processes. Thus, there remains an unmet need in the art for high temperature heating chuck assemblies exhibiting improved thermal uniformity and mechanical stability, e.g., flatness, more particularly, for both novel structures, and attendant heating modalities for same.

### SUMMARY OF THE INVENTION

A heating chuck assembly for wafer processing is provided, including heating modalities for same. The assembly generally includes hermetically sealed opposingly paired discs, and housed therebetween, a ceramic element interposed between first and second heating elements. The first heating element is adjacent a first disc of the opposingly paired discs so as to be paired therewith, the second heating element adjacent a second disc of the opposingly paired discs so as to be paired therewith. The assembly further contemplates the inclusion of temperature sensing/measuring and controlling devices, in the context of a heating chuck system.

The discs, which advantageously are selected from the group consisting of aluminum, stainless steel, nickel, or alloys thereof, essentially house dual heating elements, more particularly, dual mica heaters having a ceramic element interposed therebetween. Preferably, the heating elements are substantially identical, characterized by substantially similar watt densities and heating profiles. Although not necessary, it is further advantageous that the heating elements have greater than one heating zone, and, generally, not more than four separately operable heating zones, with greater than four heating zones nonetheless contemplated and a function of heat sink area, thickness, uniformity, materials, etc. Operatively, the heating elements may function individually, in parallel, or simultaneously.

The discs, which are generally sealed about a common periphery, are further united interior of the common periphery via a plurality of bosses. In furtherance of thermal and mechanical stability, the assembly of the subject invention advantageously includes bosses spaced on about three inch centers for the device described herein, boss spacing being less or greater to the extent that the plate is thinner or thicker. More specific features and advantages obtained in view of those features will become apparent with reference to the drawing figures and DETAILED DESCRIPTION OF THE INVENTION.

### BRIEF DESCRIPTION OF THE DRAWINGS

Referring now to the drawings wherein like numerals are used to designate like parts of the invention throughout the figures:

FIG. 1 illustrates a conventional high temperature heating chuck in exploded perspective plan view depicting heretofore known, typical components thereof;

FIG. 2 illustrates, in perspective view, a heating chuck assembly of the subject invention;

FIG. 3 is a sectional view of the heating chuck assembly of FIG. 2;

FIG. 3a is a detailed view of area “3a” of FIG. 3 showing the heating elements of the assembly of FIG. 2;

FIG. 4 is a plan view of the bottom plate of the heating chuck assembly of FIG. 3, i.e., an overhead view of the FIG. 2 structure;

FIG. 5 is a plan view of the top (i.e., wafer receiving) plate of the heating chuck assembly of FIG. 3, i.e., an underside view of the FIG. 2 structure; and,

FIG. 5A illustrates the plate of FIG. 5 with preferred heating zones indicated.

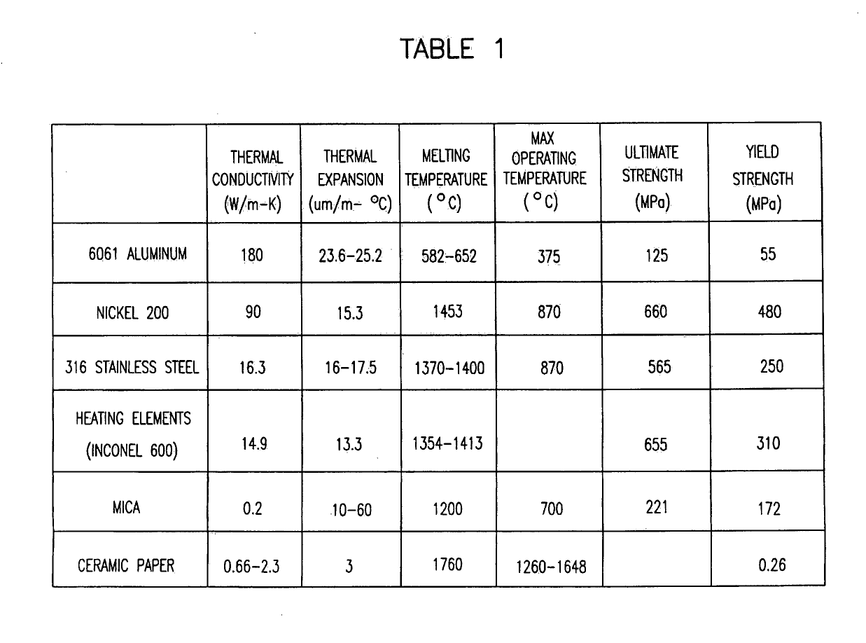

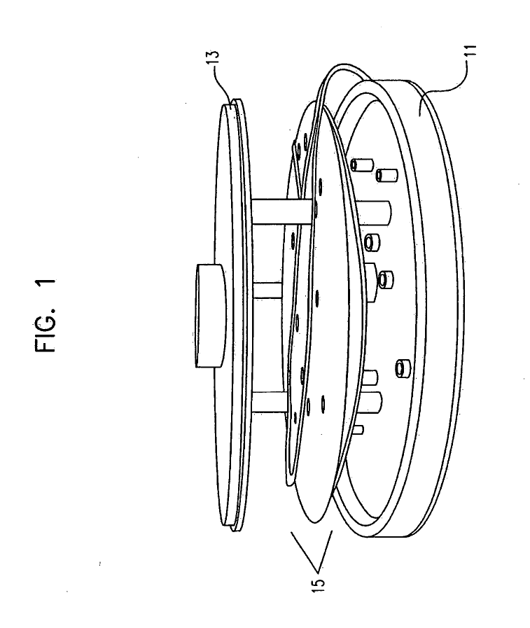

### DETAILED DESCRIPTION OF THE INVENTION

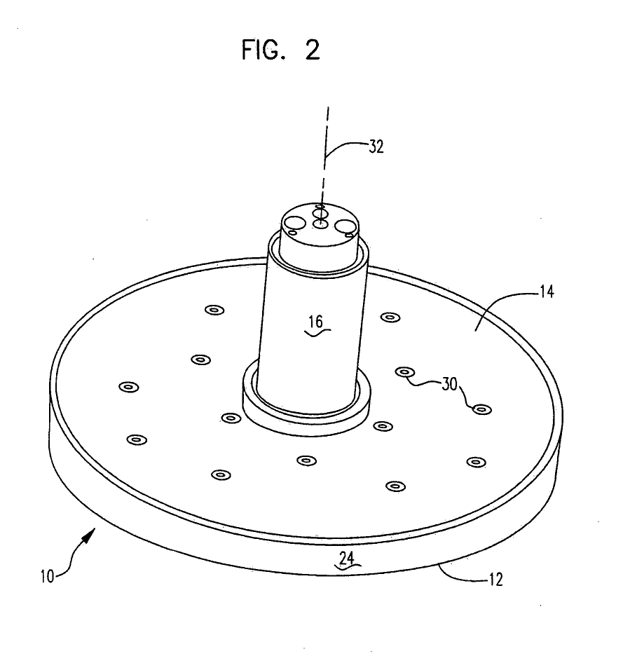

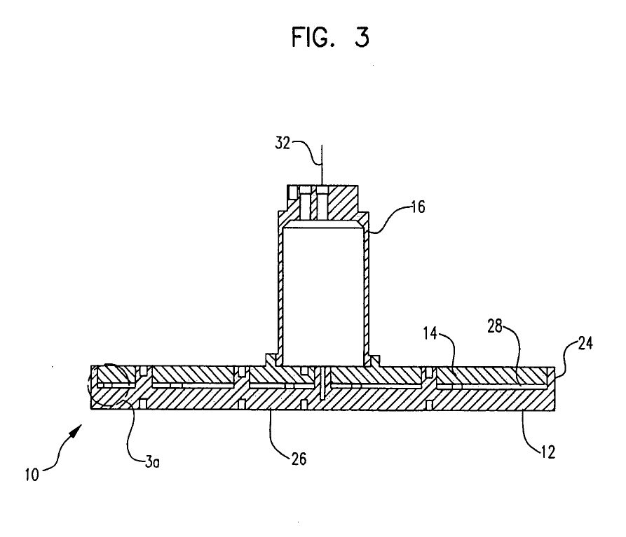

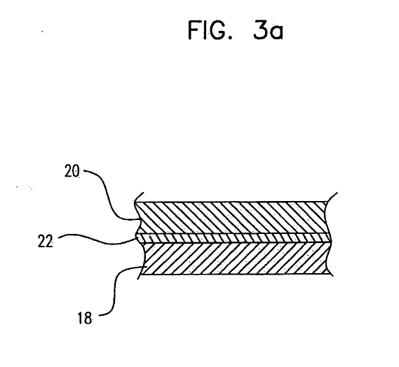

The heating chuck assembly of the subject invention is generally shown in FIG. 2, with details thereof illustrated in FIGS. 3-5. As a preliminary matter, although the subject disclosure is generally directed to “high” temperature wafer processing, i.e., at temperatures up to about 600° C., the subject assembly is not intended to be so limited. The subject assembly, more particularly, a 6061 aluminum alloy chuck, demonstrated particular utility in a thermal range of about 100-300° C.

With general reference to the figures, the subject assembly 10 generally includes hermetically sealed opposingly paired discs or plates 12, 14 supported upon a stem 16, namely, a top or wafer receiving plate 12, and a bottom or stem receiving plate 14. It is to be noted that the notions or conventions of “top,” “bottom,” “up,” “down,” etc., as the case may be, are relative, and primarily provided to facilitate a discussion of feature relationships and/or interrelationships.

The assembly 10 further, and advantageously, includes first 18 and second 20 heating elements, i.e., heaters, each heating element being adjacent to each plate of the opposingly paired plates in the assembly. Essentially, each plate of the set or pair has an associated or paired heater. Interposed at least between the first 18 and second 20 heating elements is one or more sheets of ceramic paper 22 or the like. As will later be discussed, the heaters are preferably mica heaters.

The chuck plates are advantageously fabricated from aluminum, and alloys thereof (e.g., 6061), stainless steel, or nickel, with aluminum alloys being preferred for thermal applications below about 375° C., due to, among other things, their high thermal conductivity, light weight, ease of machinabilty and ability to be welded (i.e., hermetically united via electron beam welding). For thermal processing in excess of about 375° C., stainless steel and nickel are options, with nickel generally providing a five fold increase in thermal conductivity compared to stainless steel, and with nickel (i.e., Ni 200) offering a lower degree of thermal deformation as compared with stainless steel (i.e., 316 SS). Thermophysical properties of select elements of the chuck assembly of the subject invention are summarized in Table 1 herein.

With particular reference to FIGS. 3-5, the top plate 12 is generally adapted to receive the bottom plate 14, e.g., as shown, the top plate 12 includes a rim 24, more particularly, a peripheral sidewall, within which the bottom plate 14 is received. The top plate 12 further includes opposing plate surfaces, i.e., an “exterior” or wafer receiving plate surface 26 and an “interior” or heater receiving plate surface 28.

The bottom plate 14 is generally adapted for cooperative engagement with the stem 16, as is generally well known in the art. Likewise, the stem is of conventional design and is functionally required to, among other things, support the subassembly of plates, heaters, etc.

The bottom plate 14 generally includes a plurality of supporting bosses 30, with about a three inch span between adjacent bosses believed advantageous, and thus preferred. Functionally, the supporting bosses must be capable of withstanding the shearing forces acting from the upper and the lower plates. During the heating and vacuuming processes, the welded boss joints experience continuous shearing forces. Any slightly uneven supports, or weak weld joints, may cause deformation in the plates. Thus, the number of the supporting bosses, and their locations (i.e., general configuration thereof) are a further consideration in an improved chuck assembly configuration.

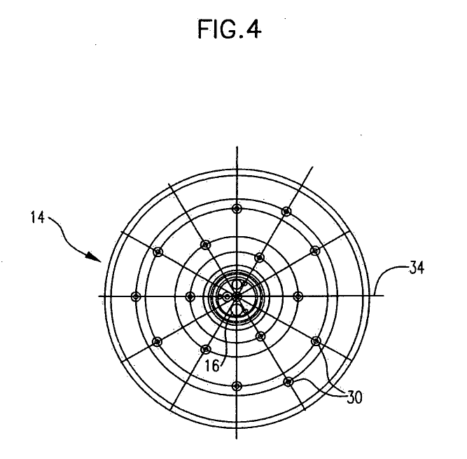

With reference to FIG. 4, a particularly advantageous boss configuration is shown in connection with a 6061 anodized aluminum plate/mica heater assembly for a 300 mm wafer, more particularly, for a 13 inch diameter chuck having about a 1.15 inch thickness (i.e., 0.5 inch top plate thickness, 0.5 inch bottom plate thickness, and 0.15 inch gap for the subassembly comprised of the two mica heaters and ceramic paper). Radially from an axial centerline 32, four boss rings are indicated, namely, in increasing dimensional magnitude, r1, r2, r3, and r4, with fifteen (15) total bosses, the occurrence thereof in relation the radial rings being 3/3/6/3. Furthermore, bosses are distributed in 30° angular increments from the plate centerline 34, more particularly, in a repeating occurrence of 2/1/1/1 through a 120° arc. As indicated in FIG. 4, and beginning at a “1 o'clock” position, bosses are positioned as follows: 1, r1, r4; 2, r3; 3, r2; 4, r3; 5, r1, r4; 6, r3; 7, r2; 8, r3; 9, r1, r4; 10, r3; 11, r2; and, 12, r3.

As to the heating elements of the subject invention, dual mica heaters are critical for optimal thermal and mechanical performance of the chuck, and by extension, wafer processing. Mica heaters generally include an etched foil element sandwiched between layers of mica. An organic material binds the layers together and burns off during initial warm up. Such heaters are characterized by high thermal capability, i.e., up to about 600° C., and a power rating of up to about 110 watts per square inch.

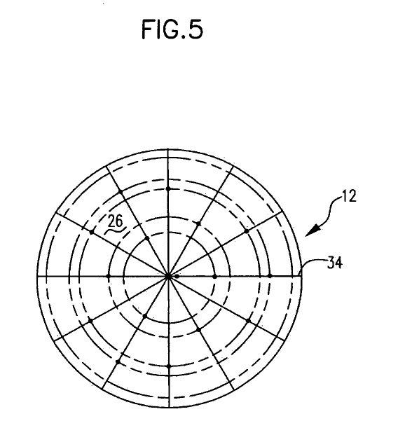

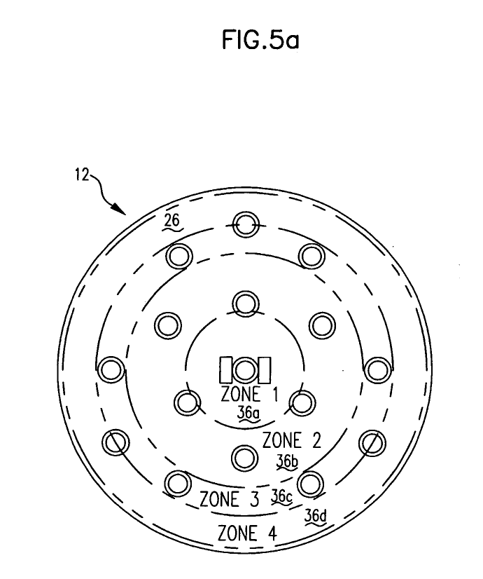

In connection to heating modalities, it is advantageous, but not necessary, that each of the heaters 18, 20 of the assembly 10 include greater than one heating zone 36, more particularly, that each heater include up to about four heating zones (i.e., independently operable heating zones 36a-36d, see e.g., FIG. 5A). Likewise, simultaneous or substantially simultaneous operation of each of the heater of the assembly is preferred. It is to be understood that attendant controllers, sensors, indicators, etc. are contemplated although not necessarily shown and/or explicitly disclosed, such items being believed well know to those of ordinary skill in the subject art.

Interposed between the “top” and “bottom” heaters is at least a single sheet of ceramic fabric paper 22, i.e., a ceramic element, or the like. Among several critical relationships in the subject assembly or subassembly, is a twofold requirement that the etched foil element and mica sheets of the heater remain substantially integrated, and that the heater per se be substantially and uniformly contacting the heat sink, i.e., plate or disc. In furtherance thereof, incorporating at least a single ceramic fabric paper sheet, e.g., about 0.125″ thick, between the dual heating elements provides a resilient padding. A plate interposed laminate structure comprising the heating elements 18, 20 and ceramic paper 22 is typically compressed by about half, and aides realization of the aforementioned relationships and interrelationships.

As illustrated in inventor testing, temperature disturbance phenomena were noted, namely, when four zones in each heater were controlled independently and simultaneously while trying to maintain the temperature at a select set temperature (see FIG. 5a), the heat transfers quickly throughout the heating chuck and affects the neighboring zones. These temperature disturbances from the neighboring zones adversely affected the overall temperature uniformity. In contrast, when running only two heaters without zones, these disturbances were not manifest. It is believed that the time response of the temperature controllers could be modified in an effort to reduce this phenomenon.

There are other variations of the subject invention, some of which will become obvious to those skilled in the art. It will be understood that this disclosure, in many respects, is only illustrative. Changes may be made in details, particularly in matters of shape, size, material, and arrangement of parts, as the case may be, without exceeding the scope of the invention. Accordingly, the scope of the subject invention is as defined in the language of the appended claims.

What is claimed is:

1. A heating chuck assembly for wafer processing, said assembly comprising hermetically sealed opposingly paired discs, and housed therebetween, a ceramic element interposed between first and second heating elements, said first heating element adjacent a first disc of said opposingly paired discs, said second heating element adjacent a second disc of said opposingly paired discs.

2. The heating chuck assembly of claim 1 wherein discs of said opposingly paired discs comprise a material selected from the group consisting of aluminum, stainless steel, nickel, or alloys thereof.

3. The heating chuck assembly of claim 1 wherein said first disc is adapted for receipt and retention of a wafer upon a surface thereof.

4. The heating chuck assembly of claim 1 wherein said second disc is adapted for cooperative engagement with a stem.

5. The heating chuck assembly of claim 4 wherein said first disc includes a depending peripheral rim.

6. The heating chuck assembly of claim 5 wherein said second disc is received within said depending rim of said first disc.

7. The heating chuck assembly of claim 1 wherein said first and second heating elements are simultaneously operable.

8. The heating chuck assembly of claim 7 wherein said first and second heating elements are independently operable.

9. The heating chuck assembly of claim 1 wherein said first and second heating elements are independently operable.

10. The heating chuck assembly of claim 7 wherein said heating elements comprise mica heaters.

11. The heating chuck assembly of claim 7 wherein said heating elements have substantially equivalent watt densities.

12. The heating chuck assembly of claim 11 wherein said heating elements have substantially equivalent heating profiles.

13. The heating chuck assembly of claim 7 wherein said heating elements have substantially equivalent heating profiles.

14. The heating chuck assembly of claim 7 wherein said heating elements comprise an etched inconel foil interposed between mica sheets.

15. The heating chuck assembly of claim 8 wherein each of said heating elements includes up to four controllable heating zones.

16. The heating chuck assembly of claim 15 wherein each zone of said up to four controllable heating zones includes a temperature sensor.

17. The heating chuck assembly of claim 1 wherein said assembly further includes a plurality of bosses, each boss of said plurality of bosses extending from a disc of said hermetically sealed opposingly paired discs to another disc of said hermetically sealed opposingly paired discs.

18. The heating chuck assembly of claim 17 wherein the bosses of said plurality of said bosses are spaced apart by about three inches.

19. The heating chuck assembly of claim 17 wherein the bosses of said plurality of bosses upwardly extend from said first disc.

20. The heating chuck assembly of claim 17 wherein the bosses of said plurality of bosses upwardly extend from said second disc.

21. The heating chuck assembly of claim 17 wherein bosses of said plurality of bosses are configured so as to be angularly spaced apart from a centerline of said sealed discs.

22. The heating chuck assembly of claim 21 wherein at least a single boss of said plurality of bosses is angularly spaced apart at a 30 degree increment from a centerline of said sealed discs.

23. The heating chuck assembly of claim 22 wherein a first group of angular increments includes double, single, single and single bosses.

24. The heating chuck assembly of claim 23 wherein said first group of angular increments is repeated three times for said sealed discs.

25. The heating chuck assembly of claim 21 wherein select bosses of said plurality of bosses are radially spaced apart from an axial centerline of said sealed discs.

26. The heating chuck assembly of claim 21 wherein a first portion of bosses of select bosses of said plurality of bosses are spaced from said axial centerline by a first radius r1.

27. The heating chuck assembly of claim 26 wherein a second portion of bosses of select bosses of said plurality of bosses are spaced from said axial centerline by a second radius r2.

28. The heating chuck assembly of claim 27 wherein a third portion of bosses of select bosses of said plurality of bosses are spaced from said axial centerline by a third radius r3.

29. The heating chuck assembly of claim 28 wherein a fourth portion of bosses of select bosses of said plurality of bosses are spaced from said axial centerline by a fourth radius r4.

30. A temperature controlled semiconductor wafer chuck system comprising a laminate structure interposed between united upper and lower chuck plates, said laminate structure comprising upper and lower heating elements separated by a ceramic element, said upper chuck plate being heated by said upper heating element, said lower chuck plate being heated by said lower heating element, said upper and said lower heating elements being separately operable.
